(19) United States
(12) Patent Application Publication
(10) Pub. No.: US 2024/0061809 A1
(43) Pub. Date: Feb. 22, 2024

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Ryosuke MURAKAMI, Kanagawa (JP)

(73) Assignee: FUJIFILM Business Innovation Corp., Tokyo (JP)

(21) Appl. No.: 18/180,453

(22) Filed: Mar. 8, 2023

(30) Foreign Application Priority Data
Aug. 22, 2022 (JP) 2022-131879

(51) Int. Cl. G06F 16/14; G06F 16/182; G06F 16/188

(52) U.S. Cl. CPC G06F 16/148; G06F 16/183; G06F 16/192

(57) ABSTRACT

An information processing apparatus includes a processor configured to notify a user of a status of use for each of plural attribute items of plural search target data on the basis of attribute use status information that indicates a status of use of an attribute item for each of the plural search target data.

### CROSS-REFERENCE TO RELATED APPLICATIONS

This application is based on and claims priority under 35 USC 119 from Japanese Patent Application No. 2022-131879 filed Aug. 22, 2022.

### BACKGROUND

### (i) Technical Field

The present disclosure relates to an information processing apparatus and a non-transitory computer readable medium.

### (ii) Related Art

Japanese Unexamined Patent Application Publication No. 2009-59217 discloses a search folder that allows data to be displayed independently of the data storage system. The search folder is a virtual folder, for which a search condition has been set in advance by a user. When the search folder is opened, data retrieved using the search condition set for the search folder are displayed. Japanese Unexamined Patent Application Publication No. 2019-220072 discloses a document management apparatus that manages document information data extracted from input electronic data and document information data input by a registering person in association with a management system defined by the registering person.

### SUMMARY

It is considered to set, as a search condition, a combination of an attribute item of a plurality of search target data as search targets and a corresponding attribute value. By using the thus set search condition, it is possible to extract search target data having a specific attribute value corresponding to a specific attribute item from among the plurality of search target data, for example.

The plurality of search target data may have a large number of attribute items, and each of the attribute items may take a large number of attribute values. In such a case, it may be difficult for a user to find a combination of what attribute item and what attribute value should be used as an appropriate search condition.

Aspects of non-limiting embodiments of the present disclosure relate to assisting a user in selecting a search condition which is a combination of an attribute item and an attribute value for searching a plurality of search target data having attribute items and attribute values.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to notify a user of a status of use for each of a plurality of attribute items of a plurality of search target data on a basis of attribute use status information that indicates a status of use of an attribute item for each of the plurality of search target data.

### BRIEF DESCRIPTION OF THE DRAWINGS

An exemplary embodiment of the present disclosure will be described in detail based on the following figures, wherein:

FIG. 1 schematically illustrates the configuration of an information processing system according to the present exemplary embodiment;

FIG. 2 schematically illustrates the configuration of an information processing apparatus according to the present exemplary embodiment;

FIG. 3 is a conceptual diagram illustrating an example of the content of an electronic document database (DB);

FIG. 4 is a conceptual diagram illustrating an example of the content of a search use times DB;

FIG. 5 illustrates an example of a starting folder select screen;

FIG. 6 is a first view illustrating a display example of the status of use for each of a plurality of attribute items of a plurality of search target documents;

FIG. 7 is a first view illustrating a display example of generated search folders;

FIG. 8 is a first view illustrating a display example of the status of provision of a plurality of attribute values corresponding to a selected attribute item in a plurality of search target documents;

FIG. 9 is a second view illustrating a display example of the status of provision of a plurality of attribute values corresponding to a selected attribute item in a plurality of search target documents;

FIG. 10 is a third view illustrating a display example of the status of provision of a plurality of attribute values corresponding to a selected attribute item in a plurality of search target documents;

FIG. 11 is a second view illustrating a display example of the status of use for each of a plurality of attribute items of a plurality of search target documents;

FIG. 12 is a first view illustrating the status of provision for each of a plurality of combinations of an attribute value corresponding to a first selected attribute item and an attribute value corresponding to a second selected attribute item in a plurality of search target documents;

FIG. 13 is a second view illustrating the status of provision for each of a plurality of combinations of an attribute value corresponding to a first selected attribute item and an attribute value corresponding to a second selected attribute item in a plurality of search target documents;

FIG. 14 is a second view illustrating a display example of generated search folders;

FIG. 15 is a first view illustrating a display example of the status of use for each of a plurality of attribute items of a plurality of second search target documents stored in a search folder;

FIG. 16 illustrates search folders generated under a search folder;

FIG. 17 illustrates an example of an attribute value addition notification; and

FIG. 18 is a flowchart illustrating the flow of a process by the information processing apparatus according to the present exemplary embodiment.

### DETAILED DESCRIPTION

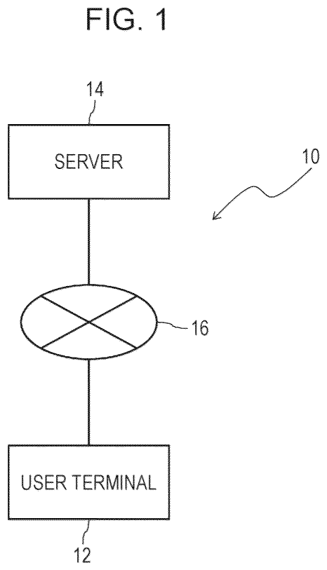

FIG. 1 schematically illustrates the configuration of an information processing system 10 according to the present exemplary embodiment. The information processing system 10 is constituted to include one or more user terminals 12 to be used by one or more users and a server 14 that serves as an information processing apparatus. The user terminals 12 and the server 14 are connected so as to be communicable with each other via a communication line 16 such as a Local Area Network (LAN) or a Wide Area Network (WAN).

The user terminal 12 may be, but is not limited to, a computer such as a personal computer, a tablet terminal, and a smartphone, for example. The user terminal 12 is constituted to include a communication interface for communication with the server 14 via the communication line 16, an input interface that receives an instruction from a user, a display that displays a variety of screens, a memory that stores data, a processor that executes various processes, etc.

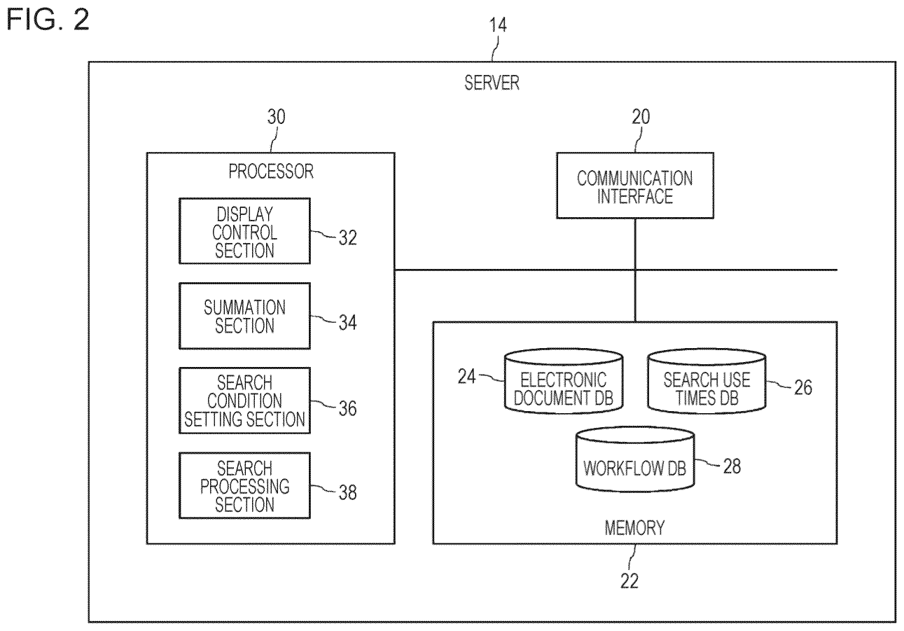

FIG. 2 schematically illustrates the configuration of the server 14 according to the present exemplary embodiment. The server 14 may be constituted by a single computer, or may be constituted through collaboration of a plurality of computers.

The server 14 provides the user with a data management service. In the present exemplary embodiment, the server 14 provides the user with a document management service for managing electronic documents as data. The data to be managed by the data management service provided by the server 14 are not limited to electronic documents. Such data may be image data, music data, program data, etc., for example.

The document management service is a service that manages electronic documents received from the user in a searchable manner and that searches the managed electronic documents in response to a request from the user to provide extracted electronic documents to the user. As discussed later, the document management service may enable defining a workflow that prescribes the flow of a sequence of work such as operations, and enable managing electronic documents along the defined workflow.

A communication interface 20 is constituted from a network interface card (NIC) etc. The communication interface 20 exhibits the function of communicating with other devices such as the user terminals 12 via the communication line 16.

The memory 22 is constituted to include a hard disk drive (HDD), a solid state drive (SSD), an embedded multimedia card (eMMC), a read only memory (ROM), a random access memory (RAM), etc. The memory 22 stores an information processing program that causes various portions of the server 14 to operate. The information processing program may be stored in a non-transitory computer-readable storage medium such as a Universal Serial Bus (USB) memory or a compact disk read only memory (CD-ROM), for example. The server 14 is able to read the information processing program from such a storage medium and execute the information processing program. As illustrated in FIG. 2, the memory 22 stores an electronic document database (DB) 24, a search use times DB 26, and a workflow DB 28.

One or more physical folders are defined in advance in the memory 22, and a processor 30 to be discussed later stores electronic documents received from the user terminals 12 in the physical folders to manage the electronic documents.

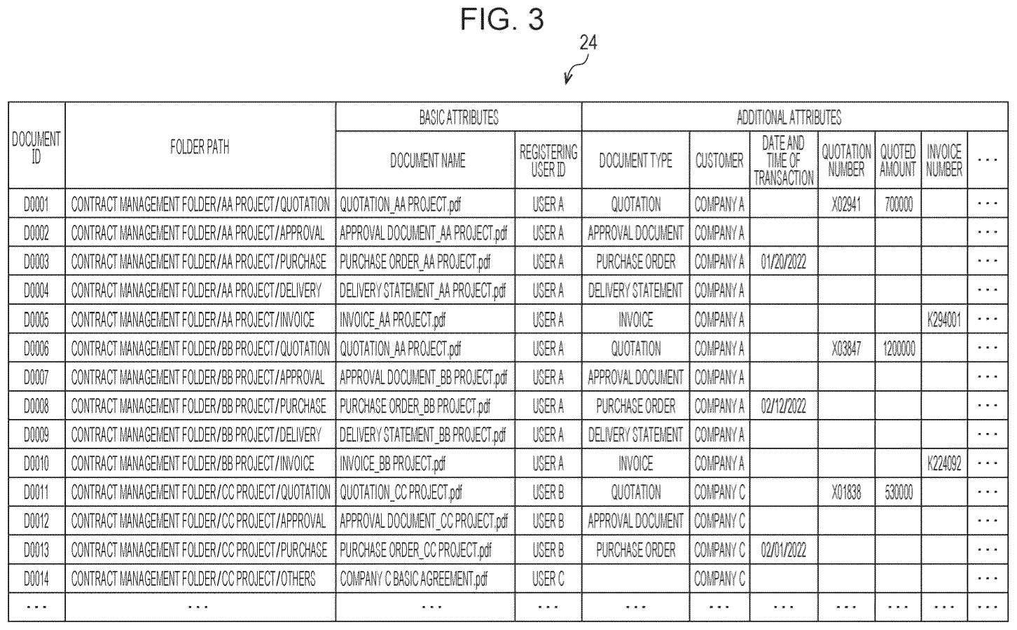

The electronic document DB 24 is a database that stores attribute information on electronic documents managed by the document management service. FIG. 3 illustrates an example of the content of the electronic document DB 24. As illustrated in FIG. 3, the electronic document DB 24 stores a document identifier (ID) that uniquely identifies an electronic document, a folder path that indicates the path to a physical folder that stores the electronic document, and attribute information on the electronic document, in association with each other.

In the present exemplary embodiment, the attribute information is divided into basic attributes and additional attributes. Examples of the basic attributes include a document name that indicates the name of the electronic document and a registering user ID that uniquely identifies a user that has registered the electronic document in the document management service. The additional attributes indicate the content, purpose of use, etc. of the electronic document. Examples of the additional attributes include type of the electronic document, customer, date and time of transaction, quotation number, quoted amount, invoice number, etc. for a transaction made using the electronic document. As illustrated in FIG. 3, the attribute information is constituted from attribute items (such as “registering user ID”, “document type”, and “customer”, for example) and attribute values (such as “user A”, “quotation”, and “company A”, for example) for the attribute items.

Fields in FIG. 3 with no attribute values indicate that the electronic document does not have an attribute value for the attribute item. As also indicated in FIG. 3, attribute items that have an attribute value are different among the electronic documents. For example, when focus is given to the additional attributes, an electronic document indicated by a document ID “D0001” has an attribute value for attribute items “document type”, “customer”, “quotation number”, and “quoted amount”, but does not have an attribute value for the other attribute items. On the other hand, an electronic document indicated by a document ID “D0002” has an attribute value for attribute items “document type” and “customer”, but does not have an attribute value for the other attribute items. While attribute items that have an attribute value depend on the document type in the example in FIG. 3, attribute items that have an attribute value may be different among a plurality of electronic documents of the same document type.

In the case where an electronic document has an attribute value for a certain attribute item, it may be considered that the electronic document uses the attribute item. Thus, the attribute information stored in the electronic document DB 24 corresponds to attribute use status information that indicates the status of use of attribute items for each of the electronic documents managed by the document management service.

When an electronic document is received from the user terminal 12, the processor 30 to be discussed later stores the electronic document in a physical folder, and registers information about the electronic document, including attribute information on the electronic document, in the electronic document DB 24.

In the case where data managed by the server 14 are data other than electronic documents, the memory 22 stores a database that manages such data, in place of the electronic document DB 24.

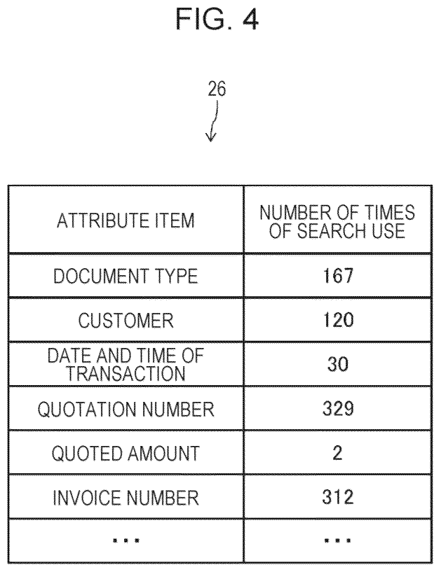

The search use times DB 26 is a database that stores search use times information that indicates the number of times of search use in which an attribute value corresponding to an attribute item has been used to search electronic documents for each of a plurality of attribute items of a group of electronic documents managed by the document management service. FIG. 4 illustrates an example of the content of the search use times DB 26. The document management service allows a user to search electronic documents by designating a search condition. The search condition is constituted from a combination of an attribute item and an attribute value. For example, when the user designates a search condition composed of a combination of an attribute item “document type” and an attribute value “quotation”, the processor 30 extracts electronic documents that have an attribute item “document type” and an attribute value “quotation” for the attribute item, from among a group of electronic documents managed by the document management service (or a group of electronic documents stored in a specific folder selected by the user). At this time, the processor 30 increments the number of times of search use for the attribute item “document type”, which is included in the search condition, by one in the search use times DB 26. In this case, the processor 30 increments the number of times of search use for the attribute item “document type” by one, irrespective of the attribute value included in the search condition (in other words, also in the case where the search condition is a combination of an attribute item “document type” and a different attribute value (e.g. “purchase order”).

In the case where an attribute value for a certain attribute item is designated as a search condition, it may be considered that the attribute item is used. Thus, the search use times information stored in the search use times DB 26 also corresponds to the attribute use status information that indicates the status of use of attribute items for each of the electronic documents managed by the document management service.

The workflow DB 28 is a database that stores workflow information about a defined workflow. As discussed above, the document management service enables the user to define a workflow that prescribes the flow of a sequence of work such as operations. In particular, a workflow that may be defined using the document management service is a workflow about work in which an electronic document is used as process data. The workflow may be defined in accordance with the document type. For example, a workflow that prescribes the work of preparing a purchase order and registering the purchase order in the document management service as a first step, the work of a person in charge of a relevant section approving the purchase order as a second step, the work of a person in charge of a purchase department approving the purchase order as a third step, and the work of performing a purchasing process on the basis of the purchase order as a fourth step may be defined as a workflow for a purchase order.

It is also possible to define a workflow in which work with mutually different contents is performed in accordance with attribute values corresponding to a specific attribute item of an electronic document. When the workflow for a purchase order discussed above is used as an example, a plurality of steps (second-first step and second-second step) in which mutually different operations are prescribed may be defined in the second step, and it may be selected which of the steps is taken in accordance with an attribute value of the purchase order, for example. Specifically, the workflow may be defined so as to pass by way of the second-first step, which prescribes the work of a department manager of the relevant section approving the purchase order, in the case where an attribute value for an attribute item “purchase amount” of the purchase order is a predetermined amount or more, and so as to pass by way of the second-second step, which prescribes the work of a section manager of the relevant section approving the purchase order, in the case where an attribute value for an attribute item “purchase amount” of the purchase order is less than the predetermined amount, for example.

In the present exemplary embodiment, electronic documents to be handled in a single workflow are collectively stored in a specific folder (and folders under the folder). Thus, the workflow DB 28 stores information about a defined workflow and a folder that stores electronic documents to be handled in the workflow in association with each other.

In the case where an attribute value for a certain attribute item is defined as a specific attribute value for determining the process content in a workflow, it may be considered that the attribute item is used. Thus, the workflow information stored in the workflow DB 28 also corresponds to the attribute use status information that indicates the status of use of attribute items for each of the electronic documents managed by the document management service.

The processor 30 refers to hardware in a broad sense. Examples of the processor 30 include general processors (e.g., CPU: Central Processing Unit) and dedicated processors (e.g., GPU: Graphics Processing Unit, ASIC: Application Specific Integrated Circuit, FPGA: Field—Programmable Gate Array, and programmable logic device). The processor 30 is broad enough to encompass one processor or plural processors in collaboration which are located physically apart from each other but may work cooperatively. The processor 30 is caused by the information processing program stored in the memory 22 to exhibit the function of a display control section 32, a summation section 34, a search condition setting section 36, and a search processing section 38.

The processor 30 is able to set a search condition for searching for a target electronic document from a group of electronic documents as a plurality of search target data managed by the document management service in accordance with an instruction from the user. By setting a search condition in advance, the user is able to easily retrieve (extract) a target electronic document at any time using the search condition.

In the present exemplary embodiment, the processor 30 sets a search condition, and then generates a virtual folder that virtually stores electronic documents retrieved using the search condition. As an icon associated with a link to an electronic document stored in a physical folder displayed on the display is displayed by opening the physical folder through double-clicking etc., a user is able to display an icon associated with a link to an electronic document retrieved using a search condition corresponding to a virtual folder by opening the virtual folder. The virtual folder is merely a virtual folder, and a plurality of electronic documents stored in the same virtual folder are not necessarily stored in the same physical folder. Herein, such a virtual folder is referred to as a “search folder”.

Electronic documents may have a large number of attribute items, and the attribute items may have wide-ranging attribute values. In such a case, it may be difficult for some users to set an appropriate search condition. Thus, in the present exemplary embodiment, the user is assisted in setting a suitable search condition. Such assistance is provided through collaboration of the display control section 32 and the summation section 34. Then, the search condition setting section 36 performs a process of setting a search condition, and the search processing section 38 performs a search using the set search condition. The details of the assisting process by the display control section 32 and the summation section 34, the details of the search condition setting process by the search condition setting section 36, and the details of the search process by the search processing section 38 will be described below.

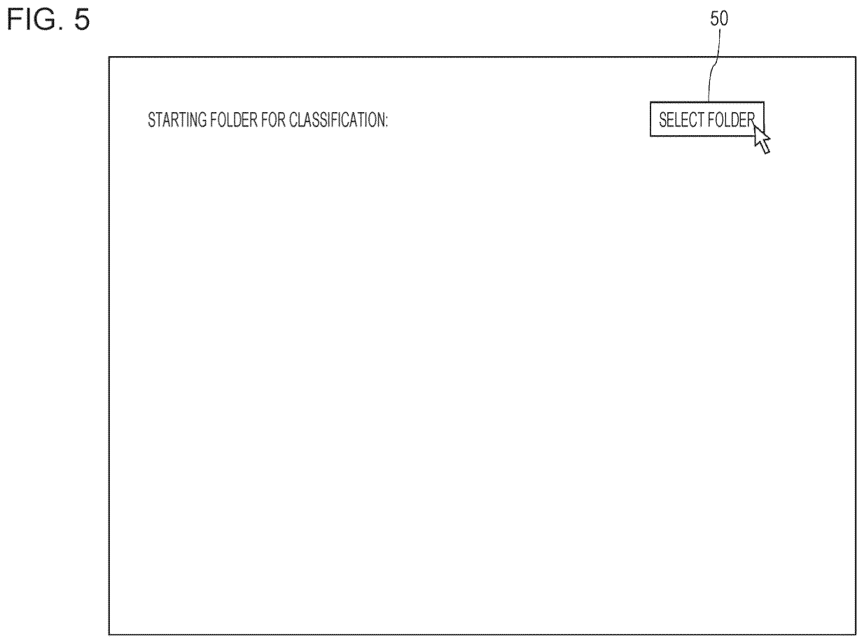

The display control section 32 displays a variety of screens related to the document management service on the display of the user terminal 12. In particular, when a request to set a search condition is received from the user terminal 12, the display control section 32 displays a starting folder select screen such as that illustrated in FIG. 5 on the display of the user terminal 12. The starting folder select screen includes a select folder button 50. The user is able to select a starting folder from among a plurality of folders defined by the document management service by operating the select folder button 50. The group of electronic documents stored in the starting folder corresponds to the plurality of search target data. That is, the group of electronic documents stored in the starting folder is to be searched using a search condition to be set. The electronic documents stored in the starting folder are referred to as “search target documents”. The starting folder may be a physical folder, or may be a search folder to be discussed in detail later.

When a starting folder is selected by the user, the summation section 34 sums the status of use for each of a plurality of attribute items of a plurality of search target documents stored in the starting folder. The summation section 34 may sum, as the status of use, a plurality of indexes to be described below.

Firstly, the summation section 34 sums an attribute provision rate that indicates the proportion of search target documents, to which an attribute value corresponding to each of a plurality of attribute items has been added, to a plurality of search target documents as the status of use for each of the plurality of attribute items of the plurality of search target documents on the basis of the attribute information as the attribute use status information stored in the electronic document DB 24. To take a simple example, the attribute provision rate of the attribute item “document type” is 0.8 (80%) in the case where, out of ten electronic documents stored in the starting folder, eight electronic documents are provided with a certain attribute value for the attribute item “document type” and the remaining two electronic documents are not provided with any attribute value for the attribute item “document type” or do not have the attribute item “document type”.

In place of or in addition to the attribute provision rate discussed above, the summation section 34 may sum an attribute provision number that indicates the number of search target documents, to which an attribute value corresponding to each of a plurality of attribute items has been added, as the status of use for each of the plurality of attribute items of the plurality of search target documents.

Secondly, the summation section 34 specifies a number of times of search use for each of a plurality of attribute items of a plurality of search target documents as the status of use for each of the plurality of attribute items on the basis of the search use times information as the attribute use status information stored in the search use times DB 26.

Thirdly, the summation section 34 specifies whether or not each of a plurality of attribute items of a plurality of search target documents is an attribute item corresponding to an attribute value for determining the process content in a workflow corresponding to the starting folder as the status of use for each of the plurality of attribute items on the basis of workflow information as the attribute use status information stored in the workflow DB 28.

The display control section 32 displays the status of use for each of a plurality of attribute items of a plurality of search target documents, summed or specified by the summation section 34, on the display of the user terminal 12. Consequently, the user is notified of the status of use for each of the plurality of attribute items of the plurality of search target documents.

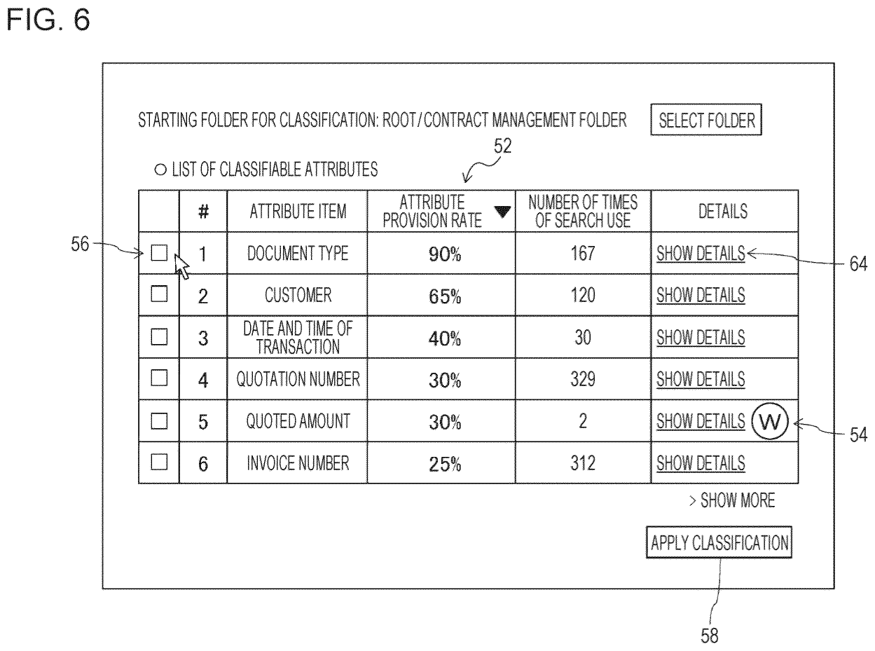

FIG. 6 illustrates a display example of the status of use for each of a plurality of attribute items of a plurality of search target documents. In FIG. 6, the display control section 32 displays an attribute item list 52 that indicates attribute items of a plurality of search target documents on the display of the user terminal 12. The attribute item list 52 includes a plurality of attribute items of a plurality of search target documents, and the status of use for the attribute items. In the example in FIG. 6, the attribute provision rate and the number of times of search use discussed above are indicated as the status of use. In the case where the summation section 34 sums an attribute provision number for the attribute items as discussed above, the attribute provision number may be displayed as the status of use.

Preferably, the display control section 32 indicates, in the attribute item list 52, whether or not each of the attribute items is an attribute item corresponding to a specific attribute value for determining the process content in a workflow associated with the starting folder. For example, a workflow icon 54 is added to an attribute item “quoted amount” in FIG. 6. This indicates that the attribute item “quoted amount” is an attribute item corresponding to an attribute value for determining the process content in a workflow associated with the starting folder.

It is possible to suitably classify (or extract) a plurality of search target documents by using an attribute item that is frequently used and a corresponding attribute value as a search condition. For example, in the example in FIG. 6, the attribute item “document type” has a high attribute provision rate, and therefore it is possible to classify (or extract) more electronic documents by using the attribute item “document type” and a corresponding attribute value as a search condition. On the contrary, if an attribute item “invoice number” with a low attribute provision rate and an attribute value of the attribute item “invoice number” are used as a search condition, few search target documents match the search condition, and electronic documents may not be classified or extracted very suitably.

It is meant that an attribute item with a larger number of times of search use is more important. Further, it is meant that an attribute item corresponding to an attribute value for determining the process of a workflow is more important. Thus, a more effective search condition may be set by including an attribute item with a larger number of times of search use, or an attribute item corresponding to an attribute value for determining the process of a workflow, in the search condition.

Consequently, the user is allowed to set a more appropriate search condition with reference to the attribute item list 52 which indicates the status of use and the effectiveness of each of the attribute items. In order to allow the user to specify an attribute item to be included in a search condition more easily, the attribute items are preferably sortable in the descending order or the ascending order of the attribute provision rate (or the attribute provision number) or the number of times of search use in the attribute item list 52.

The attribute item list 52 includes a checkbox 56 corresponding to each of the attribute items. The user is able to select a desired attribute item by operating the checkbox 56. As the user operates an apply classification button 58 displayed together with the attribute item list 52 with a selected attribute item selected, the search condition setting section 36 sets one or more combinations of the selected attribute item and attribute values for the selected attribute item of a plurality of search target documents as a search condition.

For example, it is assumed that the user has operated the apply classification button 58 with an attribute item “document type” selected in the attribute item list 52. It is assumed that attribute values “quotation”, “approval document”, “purchase order”, “delivery statement”, and “invoice” have been provided to the selected attribute item “document type” in a plurality of search target documents (i.e. a plurality of electronic documents stored in the starting folder). In that case, the search condition setting section 36 sets, as search conditions, a combination of the selected attribute item “document type” and the attribute value “quotation”, a combination of the selected attribute item “document type” and the attribute value “approval document”, a combination of the selected attribute item “document type” and the attribute value “purchase order”, a combination of the selected attribute item “document type” and the attribute value “delivery statement”, and a combination of the selected attribute item “document type” and the attribute value “invoice”. These search conditions are stored in the memory 22 so as to be selectable by the user later.

In the present exemplary embodiment, as discussed above, the search condition setting section 36 generates a search folder that virtually stores electronic documents retrieved using the set search condition. Specifically, in the case of the example discussed above, the search condition setting section 36 generates, as folders under the starting folder, a search folder “quotation” that stores electronic documents retrieved using a search condition as a combination of the attribute item “document type” and the attribute value “quotation”, a search folder “approval document” that stores electronic documents retrieved using a search condition as a combination of the attribute item “document type” and the attribute value “approval document”, a search folder “purchase order” that stores electronic documents retrieved using a search condition as a combination of the attribute item “document type” and the attribute value “purchase order”, a search folder “delivery statement” that stores electronic documents retrieved using a search condition as a combination of the attribute item “document type” and the attribute value “delivery statement”, and a search folder “invoice” that stores electronic documents retrieved using a search condition as a combination of the attribute item “document type” and the attribute value “invoice”.

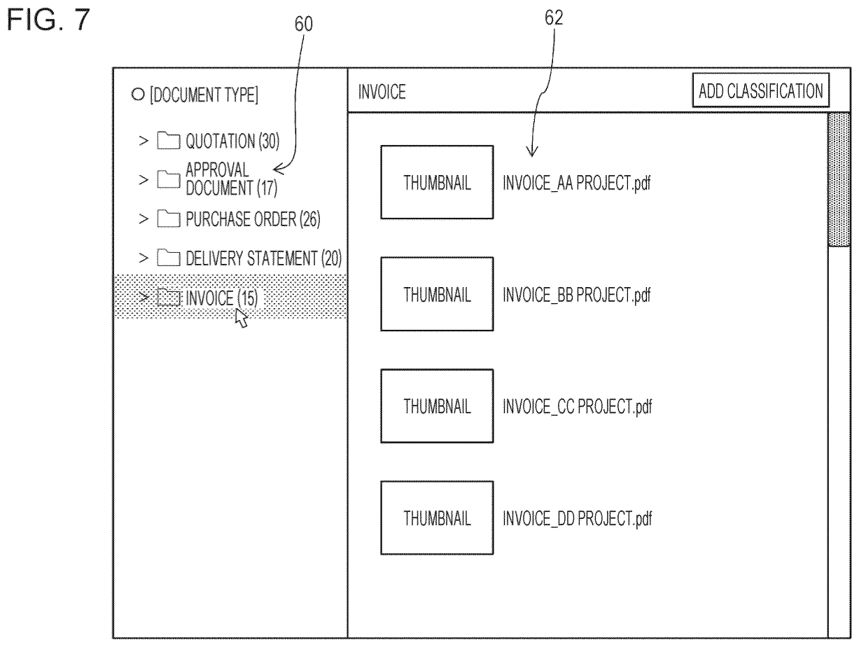

The display control section 32 displays the search folders generated by the search condition setting section 36 on the display of the user terminal 12. FIG. 7 illustrates a display example of search folders 60. When the user selects a search folder 60, the search processing section 38 searches the starting folder using a search condition corresponding to the selected search folder 60, and extracts search target documents that match the search condition. Then, the display control section 32 displays document icons 62 with a link to the search target documents extracted by the search processing section 38 on the display. Consequently, the user is allowed to search search target documents using a search condition corresponding to a search folder 60 by opening the search folder 60 as if opening a physical folder, and display document icons 62 corresponding to retrieved electronic documents.

Returning to FIG. 6, the attribute item list 52 includes show details buttons 64 corresponding to the attribute items. The show details buttons 64 are buttons for displaying the status of provision of one or more attribute values for the attribute items in a plurality of search target documents.

When a show details button 64 is operated by the user, the summation section 34 sums, as the status of provision, the number of provisions in a plurality of search target documents for each of a plurality of attribute values corresponding to the selected attribute item corresponding to the operated show details button 64 on the basis of the electronic document DB 24. Then, the display control section 32 displays the number of provisions of a plurality of attribute values for the selected attribute item, summed by the summation section 34, on the display of the user terminal 12 as the status of provision of each of the attribute values.

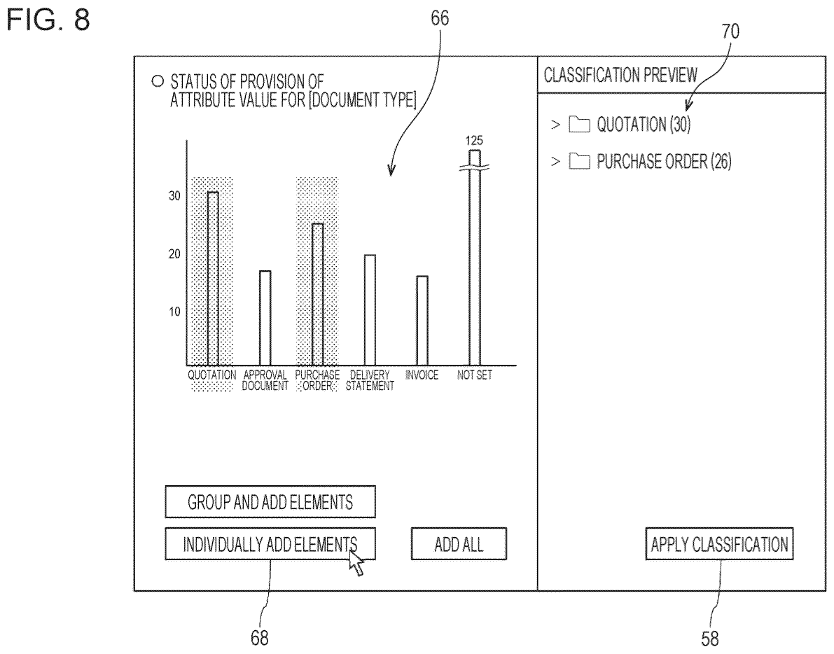

FIG. 8 illustrates a display example of the status of provision of a plurality of attribute values corresponding to a selected attribute item in a plurality of search target documents. In the example in FIG. 8, the display control section 32 displays a provision status graph 66 which is a graph that indicates the number of provisions of each of a plurality of attribute values “quotation”, “approval document”, “purchase order”, “delivery statement”, and “invoice” corresponding to a selected attribute item (here, the attribute item “document type”). The provision status graph 66 preferably indicates the number of search target documents with no attribute values corresponding to the selected attribute item, among a plurality of search target documents. In the example in FIG. 8, the number of such search target documents is displayed as “not set”.

The user is able to select an attribute value to be used as a search condition with reference to the provision status graph 66. For example, the user may use a combination of a selected attribute item and an attribute value with a larger number of provisions in the provision status graph 66 as a search condition.

When the user selects one or more attribute values in the provision status graph 66 and operates an individually add button 68 displayed together with the provision status graph 66, the display control section 32 displays a preview 70 of search folders corresponding to the combination of the selected attribute item and the selected attribute values. In the example in FIG. 8, selected attribute values “quotation” and “purchase order” are selected by the user, and therefore the display control section 32 displays a preview 70 of a search folder corresponding to a combination of the selected attribute item “document type” and the selected attribute value “quotation” and a search folder corresponding to a combination of the selected attribute item “document type” and the selected attribute value “purchase order”.

When the user operates an apply classification button 58, the search condition setting section 36 sets a combination of the selected attribute item and the selected attribute values as a search condition. In the example in FIG. 8, selected attribute values “quotation” and “purchase order” are selected by the user, and therefore the search condition setting section 36 sets a search condition which is a combination of the selected attribute item “document type” and the selected attribute value “quotation” and a search condition which is a combination of the selected attribute item “document type” and the selected attribute value “purchase order”. In the present exemplary embodiment, the search condition setting section 36 generates two search folders corresponding to these search conditions under the starting folder.

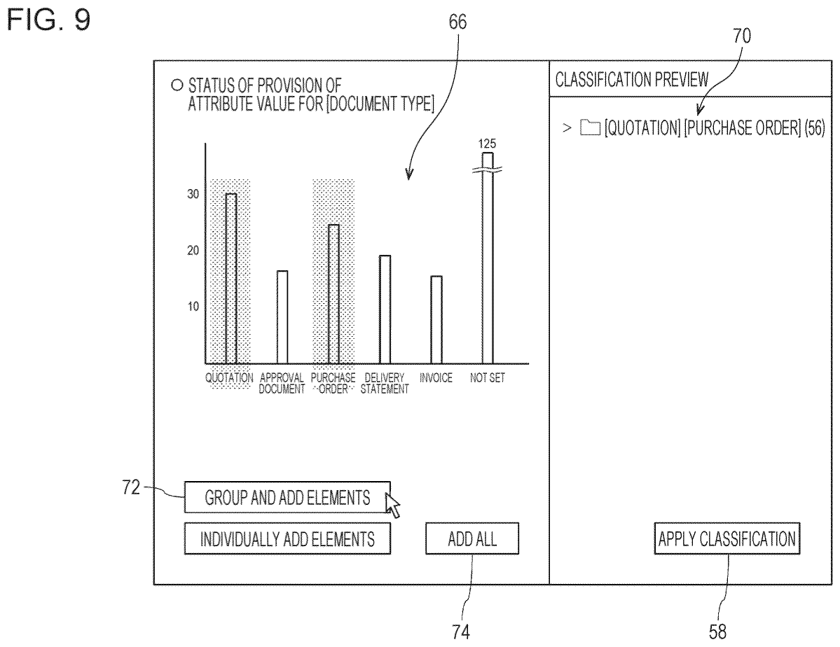

As illustrated in FIG. 9, when the user selects a plurality of attribute values in the provision status graph 66 and operates a group add button 72 displayed together with the provision status graph 66, the display control section 32 displays a preview 70 of one search folder corresponding to a combination of the selected attribute item and the plurality of selected attribute values. In the example in FIG. 9, selected attribute values “quotation” and “purchase order” are selected by the user, and therefore the display control section 32 displays a preview 70 of one search folder corresponding to a combination of the selected attribute item “document type” and the selected attribute values “quotation” and “purchase order”.

When the user operates the apply classification button 58, the search condition setting section 36 sets a combination of the selected attribute item and the plurality of selected attribute values as a search condition. In the example in FIG. 9, selected attribute values “quotation” and “purchase order” are selected by the user, and therefore the search condition setting section 36 sets a search condition which is a combination of the selected attribute item “document type” and the selected attribute values “quotation” and “purchase order”. In the present exemplary embodiment, the search condition setting section 36 generates one search folder corresponding to the search condition under the starting folder. When the user opens the search folder, the search processing section 38 retrieves electronic documents with an attribute value corresponding to the attribute item “document type” being “quotation” or “purchase order” from among a plurality of search target documents. Consequently, the search condition setting section 36 is able to set a combination of one attribute item and two or more attribute values as a search condition.

When an add all button 74 displayed together with the provision status graph 66 is operated by the user, the display control section 32 displays a preview 70 of a search folder corresponding to a combination of the selected attribute item and each of all the attribute values (including “not set”) indicated in the provision status graph 66. When the user operates the apply classification button 58, the search condition setting section 36 sets a combination of the selected attribute item and each of all the attribute values indicated in the provision status graph 66 as a search condition.

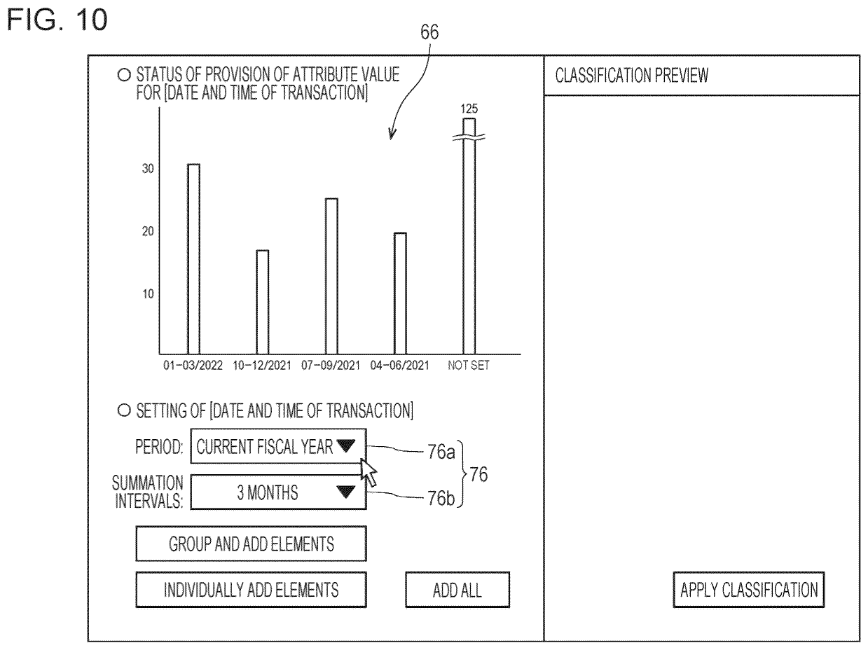

Attribute values for a selected attribute item selected by the user may take continuous values. For example, attribute values for a selected attribute item may take continuous values in the case where the attribute values represent time or numerical values. In this case, the summation section 34 divides the range of attribute values that the selected attribute item may take into a plurality of divisions, and sums a number of provisions for each of the divisions. For example, in the case where the selected attribute item is “date and time of transaction” as illustrated in FIG. 10, attribute values for the attribute item may take continuous values. In that case, the summation section 34 divides the range of attribute values into a plurality of divisions such as “01-03/2022 (January to March 2022)”, “10-12/2021”, “07-09/2021”, “04-06/2021”, and others (not set), for example, and sums the number of provisions for each of the divisions. For example, in the case where an attribute value for the attribute item “date and time of transaction” of a certain search target document is “02/05/2022”, the summation section 34 sums the search target document by considering the attribute value for the attribute item “date and time of transaction” as “01-03/2022”.

The above divisions are preferably changeable by the user. For example, in the case where attribute values for a selected attribute item may take continuous values, a division setting menu 76 is preferably displayed together with the provision status graph 66 as illustrated in FIG. 10. In the example in FIG. 10, the division setting menu 76 enables setting of a period 76a to be divided and intervals 76b of the divisions. When the user selects “current fiscal year” as the period and “3 months” as the intervals, for example, the current fiscal year (here, April 2021 to March 2022) is divided into divisions of three months. Search target documents that have date and time other than the set period as an attribute value are classified into “not set”.

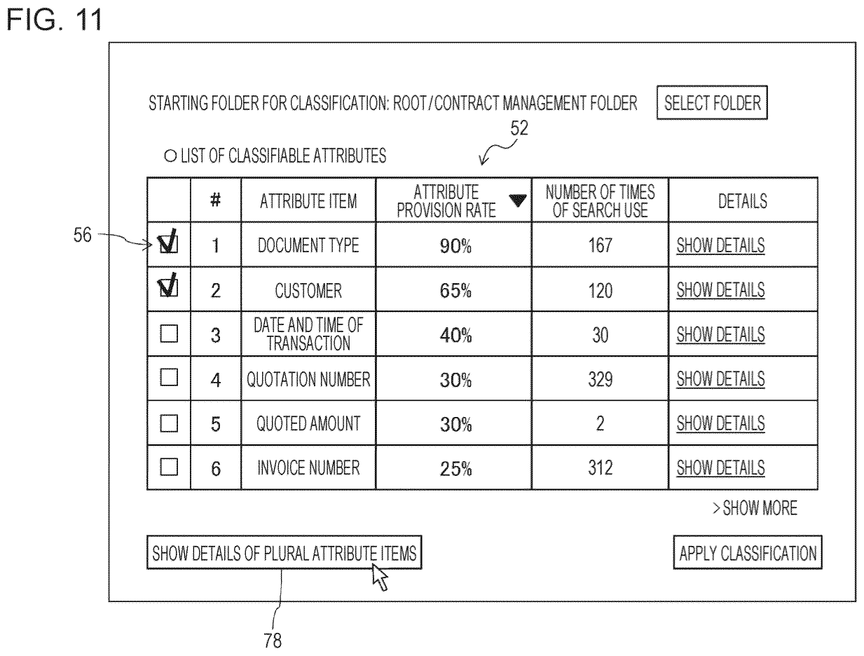

Preferably, the display control section 32 is able to display the status of provision for a combination of an attribute value corresponding to a first attribute item and an attribute value corresponding to a second attribute item in a plurality of search target documents. For example, as illustrated in FIG. 11, it is assumed that the user operates a show details button 78 with a first selected attribute item (the attribute item “document type” in the example in FIG. 11) and a second selected attribute item (the attribute item “customer” in the example in FIG. 11) selected in the attribute item list 52. In response, the summation section 34 sums the number of provisions in a plurality of search target documents for each of a plurality of combinations of an attribute value corresponding to the first selected attribute item and an attribute value corresponding to the second selected attribute item. Then, the display control section 32 displays the number of provisions in the plurality of search target documents for each of the plurality of combinations of the attribute value corresponding to the first selected attribute item and the attribute value corresponding to the second selected attribute item, summed by the summation section 34, on the display of the user terminal 12 as the status of provision of each of the attribute values.

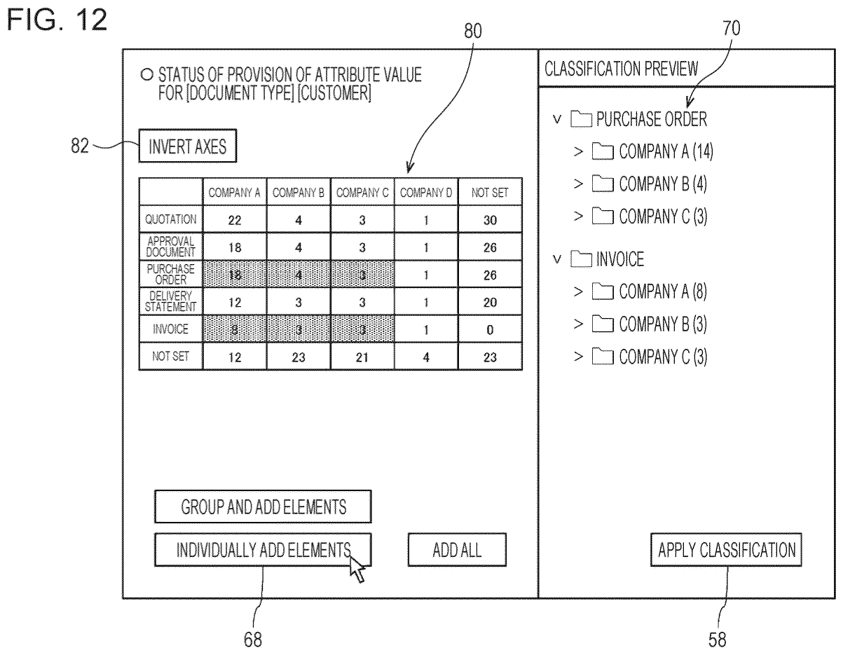

For example, the display control section 32 displays a provision status matrix 80 such as that illustrated in FIG. 12 on the display of the user terminal 12 as the status of provision. The provision status matrix 80 has a vertical axis that represents attribute values of the first selected attribute item (the attribute item “document type” in the example in FIG. 12) and a horizontal axis that represents attribute values of the second selected attribute item (the attribute item “customer” in the example in FIG. 12). For example, the number of provisions “22” at the upper left corner of the provision status matrix 80 means that there are 22 search target documents, among a plurality of search target documents, with an attribute value for the first selected attribute item “document type” being “quotation” and with an attribute value for the second selected attribute item “customer” being “company A”. When the user operates an invert axes button 82 displayed together with the provision status matrix 80, the display control section 32 displays a provision status matrix 80 in which the vertical axis and the horizontal axis have been inverted and the vertical axis represents attribute values of the second selected attribute item and the horizontal axis represents attribute values of the first selected attribute item.

When the user selects a desired cell in the provision status matrix 80 and operates the individually add button 68, the display control section 32 displays a preview 70 of search folders. In the example in FIG. 12, the display control section 32 displays two search folders corresponding to the first selected attribute item “document type” and the first selected attribute values “purchase order” and “invoice” selected in the provision status matrix 80, and displays three search folders corresponding to combinations of the second selected attribute item “customer” and the second selected attribute values “company A”, “company B”, and “company C” selected in the provision status matrix 80 as search folders under each of the search folders corresponding to the first selected attribute items “purchase order” and “invoice”.

When the user operates an apply classification button 58, the search condition setting section 36 sets a combination of the selected attribute item and the selected attribute values as a search condition. In the example in FIG. 12, two search folders corresponding to the first selected attribute item “document type” and the first selected attribute values “purchase order” and “invoice” are generated, and three search folders corresponding to combinations of the second selected attribute item “customer” and the second selected attribute values “company A”, “company B”, and “company C” selected in the provision status matrix 80 are generated as search folders under each of the search folders corresponding to the first selected attribute items “purchase order” and “invoice”.

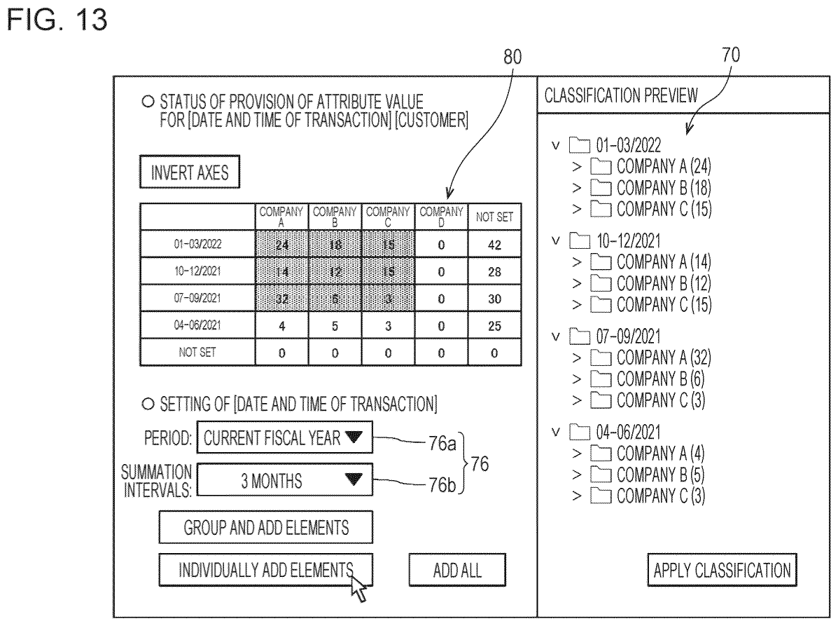

Also in the case where a provision status matrix 80 is displayed, as illustrated in FIG. 13, the summation section 34 divides the range of attribute values that the selected attribute item may take into a plurality of divisions, and sums a number of provisions for each of the divisions. Also in this case, the above divisions are preferably changeable by the user. For example, a division setting menu 76 that enables setting of a period 76a to be divided and intervals 76b of the divisions is preferably displayed together with the provision status matrix 80 as illustrated in FIG. 13.

In the present exemplary embodiment, it is possible to set a new search condition using a search folder generated by the search condition setting section 36 as the starting folder and using electronic documents virtually stored in the starting folder as search target documents (referred to as second search target documents as second search target data). That is, it is possible to generate a search folder under another search folder.

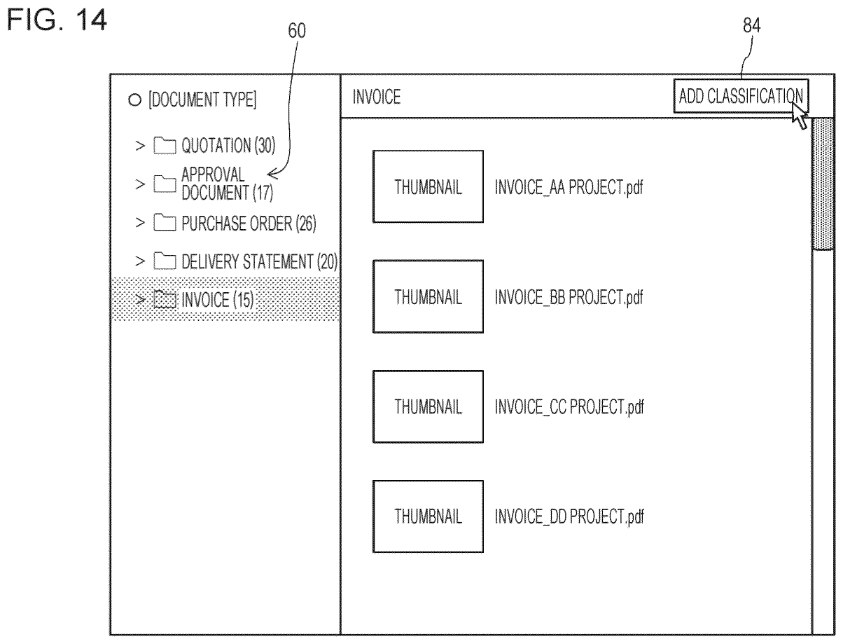

Specifically, as illustrated in FIG. 14, when an add classification button 84 is operated with the user selecting a certain search folder on the screen displaying search folders 60, the user is able to select the selected search folder as the starting folder.

When the add classification button 84 is operated by the user, the summation section 34 sums the status of use for each of a plurality of attribute items of a plurality of second search target documents retrieved using a search condition corresponding to the search folder as the starting folder. Here again, the summation section 34 sums the attribute provision rate (or the attribute provision number) for each of a plurality of attribute items of a plurality of second search target documents, or specifies whether or not the attribute item is an attribute item corresponding to an attribute value for determining the number of times of search use or the process content in a workflow, as the status of use as discussed above.

The display control section 32 displays the status of use for each of a plurality of attribute items of a plurality of second search target documents, summed or specified by the summation section 34, on the display of the user terminal 12. Consequently, the user is notified of the status of use for each of the plurality of attribute items of the plurality of second search target documents.

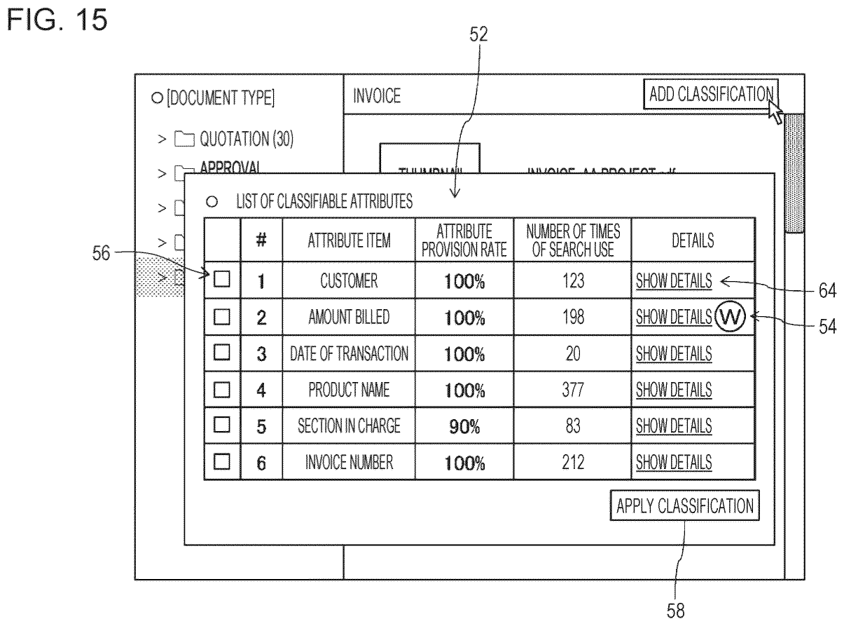

FIG. 15 illustrates a display example of the status of use for each of a plurality of attribute items of a plurality of second search target documents. Also in FIG. 15, as in FIG. 6, the display control section 32 displays an attribute item list 52 that indicates attribute items of a plurality of second search target documents on the display of the user terminal 12. The attribute item list 52 includes a plurality of attribute items of a plurality of second search target documents, and the status of use for the attribute items. Also in the example in FIG. 15, the attribute provision rate and the number of times of search use discussed above are indicated as the status of use. The attribute provision number may be displayed as the status of use. The display control section 32 displays, in the attribute item list 52, a workflow icon 54 that indicates whether or not each of the attribute items is an attribute item corresponding to a specific attribute value for determining the process content in a workflow associated with the starting folder. Here again, the user is allowed to set a more appropriate search condition for searching a plurality of second search target documents with reference to the attribute item list 52.

In response to the user selecting a selected attribute item by operating a checkbox 56 and operating the apply classification button 58 displayed together with the attribute item list 52, the search condition setting section 36 sets one or more combinations of the selected attribute item and attribute values for the selected attribute item of a plurality of search target documents as a search condition. In the present exemplary embodiment, the search condition setting section 36 generates a search folder that virtually stores electronic documents retrieved using the set search condition. The search folder generated here is a search folder generated under a search folder as the starting folder.

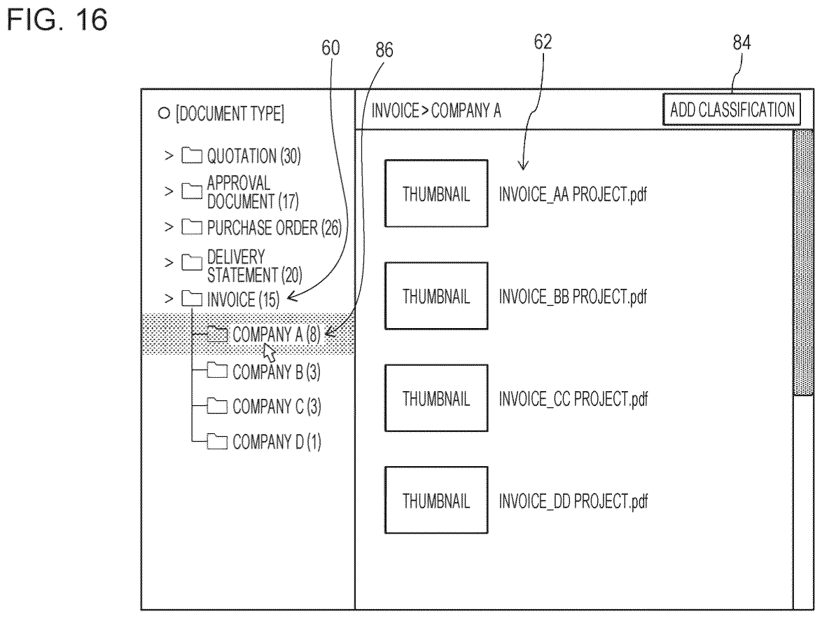

The display control section 32 displays the search folders generated by the search condition setting section 36 on the display of the user terminal 12. FIG. 16 illustrates a display example of search folders 86 generated under a search folder 60. When the user selects a search folder 86, the search processing section 38 searches a search folder 60, which is superior to the search folder 86, using a search condition corresponding to the selected search folder 86, and extracts search target documents that match the search condition. Then, the display control section 32 displays document icons 62 with a link to the search target documents extracted by the search processing section 38 on the display.

Further, the user is able to set a search condition using a search folder 86 as the starting folder by operating the add classification button 84 while selecting the search folder 86. That is, the search condition setting section 36 is able to generate a search folder under the search folder 86.

Returning to FIG. 15, when a show details button 64 is operated by the user, the summation section 34 sums, as the status of provision, the number of provisions in a plurality of second search target documents for each of a plurality of attribute values corresponding to the selected attribute item corresponding to the operated show details button 64 on the basis of the electronic document DB 24. Then, the display control section 32 displays the number of provisions of a plurality of attribute values for the selected attribute item, summed by the summation section 34, on the display of the user terminal 12 as the status of provision of each of the attribute values (see FIGS. 8 to 10). Here again, the user is able to select an attribute value to be used as a search condition for searching a plurality of second search target documents with reference to the status of provision of each of the attributes (e.g. the provision status graph 66).

A new attribute value that has not been provided so far is occasionally provided to a certain attribute item of a plurality of search target documents included in the starting folder after the search condition setting section 36 sets a search condition using a certain folder as the starting folder.

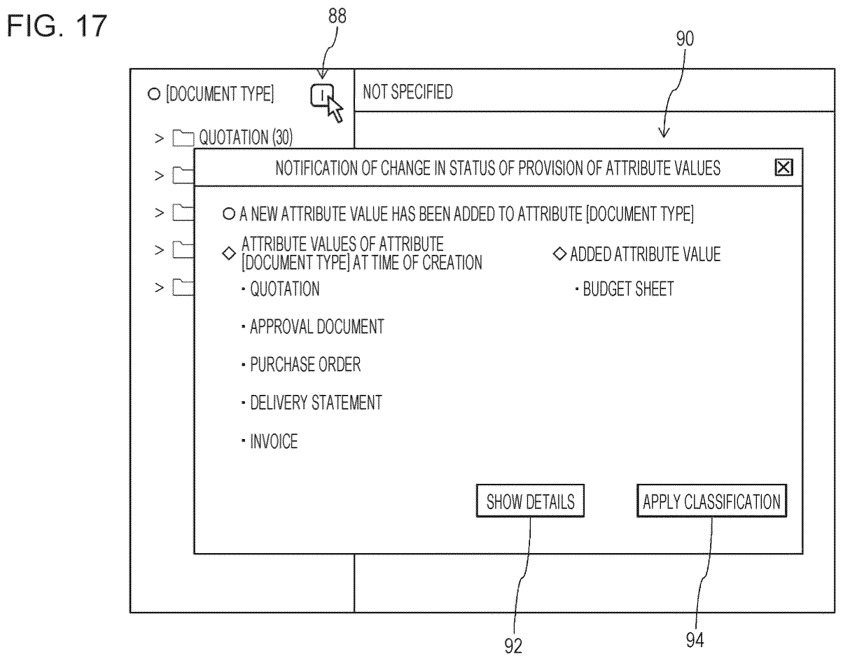

In consideration of such a case, the display control section 32 preferably notifies the user in the case where a new attribute value that has not been provided so far is provided to an attribute item included in a search condition in a plurality of search target documents included in the starting folder, for which the search condition has been set. In the present exemplary embodiment, the display control section 32 displays a notification icon 88 as illustrated in FIG. 17. Then, when the user operates the notification icon 88, a change notification dialog 90 for indicating a change to the status of provision of an attribute value is preferably displayed.

The change notification dialog 90 indicates an attribute item (the attribute item “document type” in the example in FIG. 17) included in the set search condition, attribute values (the attribute values “quotation”, “approval document”, “purchase order”, “delivery statement”, and “invoice” in the example in FIG. 17) provided to the attribute item for a plurality of search target documents included in the starting folder at the time when the search condition is set, and a newly provided attribute value (“budged sheet” in the example in FIG. 17). The change notification dialog 90 allows the user to easily understand that a new attribute value has been provided to an attribute item included in the search condition in a plurality of search target documents included in the starting folder, for which the search condition has been set.

The change notification dialog 90 includes a show details button 92 and an apply classification button 94. When the user operates the show details button 92, the summation section 34 sums again the status of use for each of a plurality of attribute items of a plurality of search target documents stored in the starting folder, and the display control section 32 displays the results of the summation by the summation section 34 (see FIGS. 6, 8, etc.). When the user operates the apply classification button 94, the search condition setting section 36 newly sets a search condition composed of the attribute item “document type” and the newly added attribute value “budged sheet”. In the present exemplary embodiment, the search condition setting section 36 generates a search folder corresponding to the search condition.

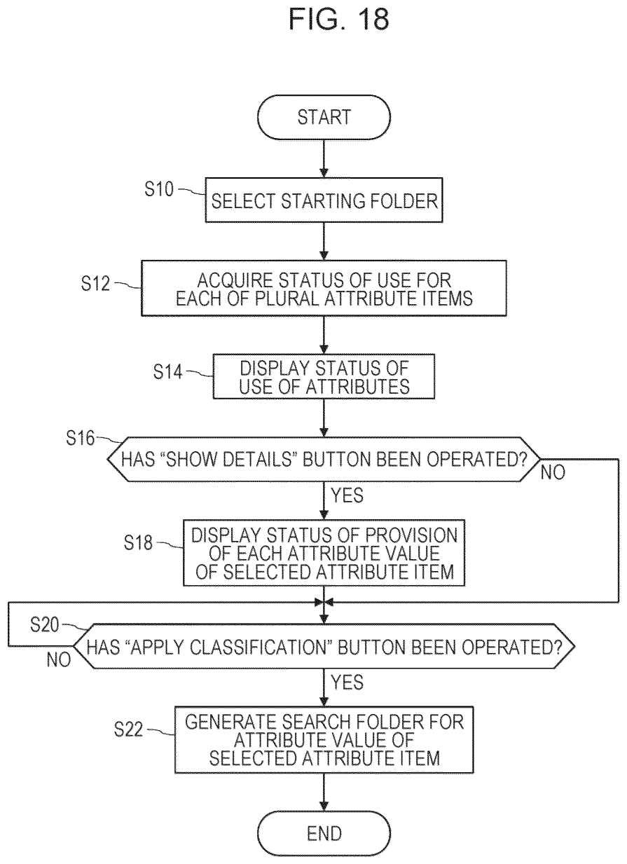

An overview of the configuration of the information processing system 10 according to the present exemplary embodiment has been described above. The flow of a process by the server 14 will be described below with reference to the flowchart illustrated in FIG. 18.

In step S10, when a request to set a search condition is received from the user terminal 12, the display control section 32 displays a starting folder select screen (see FIG. 5) on the display of the user terminal 12. In response, the user selects a starting folder.

In step S12, the summation section 34 acquires the status of use for each of a plurality of attribute items of a plurality of search target documents stored in the starting folder selected in step S10.

In step S14, the display control section 32 displays an attribute item list 52, which indicates the status of use for each of the plurality of attribute items acquired in step S12, on the display of the user terminal 12 (see FIG. 6).

In step S16, the display control section 32 determines whether or not a show details button 64 (see FIG. 6) displayed together with the attribute item list 52 has been operated by the user. The process proceeds to step S18 in the case where the show details button 64 has been operated, and proceeds to step S20 by bypassing step S18 in the case where the show details button 64 has not been operated.

In step S18, the summation section 34 sums the number of provisions in a plurality of search target documents for each of a plurality of attribute values corresponding to a selected attribute item corresponding to the show details button 64 operated in step S16. The display control section 32 displays a provision status graph 66 or a provision status matrix 80 (see FIG. 8 or 12) that indicates the number of provisions of a plurality of attribute values for the a selected attribute item, summed by the summation section 34, on the display of the user terminal 12.

In step S20, the search condition setting section 36 determines whether or not an apply classification button 58 displayed together with the provision status graph 66 or the provision status matrix 80 has been operated by the user. The process proceeds to step S22 in the case where the apply classification button 58 has been operated.

In step S22, the search condition setting section 36 sets a combination of the selected attribute item and a selected attribute value selected by the user in step S20 as a search condition, and generates a search folder that virtually stores electronic documents retrieved using the search condition.

While an exemplary embodiment of the present disclosure has been described above, the present disclosure is not limited to the above exemplary embodiment, and a variety of changes may be made without departing from the scope and spirit of the present disclosure.

For example, while the server 14 implements the functions of the display control section 32, the summation section 34, the search condition setting section 36, and the search processing section 38 in the above exemplary embodiment, these may be provided in the user terminal 12 which is able to access the electronic document DB 24, the search use times DB 26, and the workflow DB 28, and the process according to the present disclosure may be executed through local processing by the user terminal 12.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing apparatus comprising:
a processor configured to notify a user of a status of use for each of a plurality of attribute items of a plurality of search target data on a basis of attribute use status information that indicates a status of use of an attribute item for each of the plurality of search target data.
   (((2)))

The information processing apparatus according to (((1))),
wherein the attribute use status information is attribute information that indicates the attribute item for each of the plurality of search target data and an attribute value corresponding to the attribute item, and
the status of use is an attribute provision rate that indicates a proportion of search target data in which a corresponding attribute value is provided to an attribute item to the plurality of search target data, or an attribute provision number that indicates a number of search target data in which a corresponding attribute value is provided to an attribute item, for each of the plurality of attribute items.
   (((3)))

The information processing apparatus according to (((1))),
wherein the attribute use status information is search use times information that indicates a number of times of search use in which an attribute value corresponding to an attribute item has been used to search search target data for the plurality of attribute items, and
the status of use is the number of times of search use for each of the plurality of attribute items.
   (((4)))

The information processing apparatus according to (((1))),
wherein the attribute use status information is workflow information that represents a content of a workflow in which mutually different processes are performed in accordance with attribute values corresponding to a specific attribute item of process data, and
the status of use is information that indicates whether or not each of the plurality of attribute items is an attribute item corresponding to an attribute value for determining a process content in the workflow.
   (((5)))

The information processing apparatus according to (((1))),
wherein the processor is configured to set a combination of a selected attribute item and an attribute value of the plurality of search target data and corresponding to the selected attribute item in response to the user who has been notified of the status of use selecting the selected attribute item from the plurality of attribute items.
   (((6)))

The information processing apparatus according to (((1))),
wherein the processor is configured to notify the user of a status of provision in the plurality of search target data for each of a plurality of attribute values corresponding to a selected attribute item on a basis of attribute information that indicates an attribute item for each of the plurality of search target data and an attribute value corresponding to the attribute item in response to the user who has been notified of the status of use selecting the selected attribute item from the plurality of attribute items.
   (((7)))

The information processing apparatus according to (((6))),
wherein the processor is configured to notify the user of a status of provision in the plurality of search target data for each of a plurality of combinations of an attribute value corresponding to a first selected attribute item and an attribute value corresponding to a second selected attribute item in a case where the user who has been notified of the status of use selects the first selected attribute item and the second selected attribute item from the plurality of attribute items.
   (((8)))

An information processing apparatus comprising:
a processor configured to notify a user of a status of provision in a plurality of search target data for each of a plurality of attribute values corresponding to a specific attribute item of the plurality of search target data on a basis of attribute information that indicates an attribute item for each of the plurality of search target data and an attribute value corresponding to the attribute item.
   (((9)))

The information processing apparatus according to any one of (((6))) to (((8))),
wherein the processor is configured to set a combination of an attribute item corresponding to a selected attribute value and the selected attribute value as a search condition in response to the user who has been notified of the status of provision selecting the selected attribute value from the plurality of attribute values indicated by the status of provision.
   (((10)))

The information processing apparatus according to (((5))) or (((9))),
wherein the processor is configured to:
   generate a search folder which is a virtual folder that virtually stores search target data retrieved using the set search condition; and
   notify the user of a status of use for each of a plurality of attribute items of a plurality of second search target data stored in the search folder selected by the user on a basis of the attribute use status information.
      (((11)))

The information processing apparatus according to (((5))) or (((9))),
wherein the processor is configured to:
   generate a search folder which is a virtual folder that virtually stores search target data retrieved using the set search condition; and
   notify the user of a status of provision in a plurality of second search target data stored in the search folder selected by the user for each of a plurality of attribute values corresponding to a specific attribute item of the plurality of second search target data on a basis of the attribute information.
      (((12)))

An information processing program causing a computer to execute a process comprising:
notifying a user of a status of use for each of a plurality of attribute items of a plurality of search target data on a basis of attribute use status information that indicates a status of use of an attribute item for each of the plurality of search target data.
   (((13)))

An information processing program causing a computer to execute a process comprising:
notifying a user of a status of provision in a plurality of search target data for each of a plurality of attribute values corresponding to a specific attribute item of the plurality of search target data on a basis of attribute information that indicates an attribute item for each of the plurality of search target data and an attribute value corresponding to the attribute item.

What is claimed is:

1. An information processing apparatus comprising:
a processor configured to notify a user of a status of use for each of a plurality of attribute items of a plurality of search target data on a basis of attribute use status information that indicates a status of use of an attribute item for each of the plurality of search target data.

2. The information processing apparatus according to claim 1,
wherein the attribute use status information is attribute information that indicates the attribute item for each of the plurality of search target data and an attribute value corresponding to the attribute item, and
the status of use is an attribute provision rate that indicates a proportion of search target data in which a corresponding attribute value is provided to an attribute item to the plurality of search target data, or an attribute provision number that indicates a number of search target data in which a corresponding attribute value is provided to an attribute item, for each of the plurality of attribute items.

3. The information processing apparatus according to claim 1,
wherein the attribute use status information is search use times information that indicates a number of times of search use in which an attribute value corresponding to an attribute item has been used to search search target data for the plurality of attribute items, and
the status of use is the number of times of search use for each of the plurality of attribute items.

4. The information processing apparatus according to claim 1,
wherein the attribute use status information is workflow information that represents a content of a workflow in which mutually different processes are performed in accordance with attribute values corresponding to a specific attribute item of process data, and
the status of use is information that indicates whether or not each of the plurality of attribute items is an attribute item corresponding to an attribute value for determining a process content in the workflow.

5. The information processing apparatus according to claim 1,
wherein the processor is configured to set a combination of a selected attribute item and an attribute value of the plurality of search target data and corresponding to the selected attribute item in response to the user who has been notified of the status of use selecting the selected attribute item from the plurality of attribute items.

6. The information processing apparatus according to claim 1,
wherein the processor is configured to notify the user of a status of provision in the plurality of search target data for each of a plurality of attribute values corresponding to a selected attribute item on a basis of attribute information that indicates an attribute item for each of the plurality of search target data and an attribute value corresponding to the attribute item in response to the user who has been notified of the status of use selecting the selected attribute item from the plurality of attribute items.

7. The information processing apparatus according to claim 6,
wherein the processor is configured to notify the user of a status of provision in the plurality of search target data for each of a plurality of combinations of an attribute value corresponding to a first selected attribute item and an attribute value corresponding to a second selected attribute item in a case where the user who has been notified of the status of use selects the first selected attribute item and the second selected attribute item from the plurality of attribute items.

8. The information processing apparatus according to claim 6,
wherein the processor is configured to set a combination of an attribute item corresponding to a selected attribute value and the selected attribute value as a search condition in response to the user who has been notified of the status of provision selecting the selected attribute value from the plurality of attribute values indicated by the status of provision.

9. The information processing apparatus according to claim 7,
wherein the processor is configured to set a combination of an attribute item corresponding to a selected attribute value and the selected attribute value as a search condition in response to the user who has been notified of the status of provision selecting the selected attribute value from the plurality of attribute values indicated by the status of provision.

10. The information processing apparatus according to claim 5,
wherein the processor is configured to:
generate a search folder which is a virtual folder that virtually stores search target data retrieved using the set search condition; and
notify the user of a status of use for each of a plurality of attribute items of a plurality of second search target data stored in the search folder selected by the user on a basis of the attribute use status information.

11. The information processing apparatus according to claim 5,
wherein the processor is configured to:
generate a search folder which is a virtual folder that virtually stores search target data retrieved using the set search condition; and
notify the user of a status of provision in a plurality of second search target data stored in the search folder selected by the user for each of a plurality of attribute values corresponding to a specific attribute item of the plurality of second search target data on a basis of the attribute information.

12. A non-transitory computer readable medium storing a program causing a computer to execute a process comprising:
notifying a user of a status of use for each of a plurality of attribute items of a plurality of search target data on a basis of attribute use status information that indicates a status of use of an attribute item for each of the plurality of search target data.

13. A non-transitory computer readable medium storing a program causing a computer to execute a process comprising:
notifying a user of a status of provision in a plurality of search target data for each of a plurality of attribute values corresponding to a specific attribute item of the plurality of search target data on a basis of attribute information that indicates an attribute item for each of the plurality of search target data and an attribute value corresponding to the attribute item.
